(19) United States
(12) Patent Application Publication
(10) Pub. No.: US 2023/0394359 A1
(43) Pub. Date: Dec. 7, 2023

(54) TIME SERIES ANOMALY DETECTION MODEL TRAINING ACCELERATOR

(71) Applicant: Analog Devices International Unlimited Company, Limerick (IE)

(72) Inventor: Eoin Seamus Bolger, Co. Kilkenny (IE)

(21) Appl. No.: 18/137,220

(22) Filed: Apr. 20, 2023

Related U.S. Application Data
(60) Provisional application No. 63/348,640, filed on Jun. 3, 2022.

(51) Int. Cl. G06N 20/00

(52) U.S. Cl. CPC G06N 20/00

(57) ABSTRACT

Anomaly detection techniques in time series data are described. The techniques can model historical sensor data for a training period using a non-iterative acceleration technique for systems of non-linear equations. The model can include a Bayesian statistical model. The warmup period for training the model can be reduced or bypassed by setting the initial parameters of the model. The trained model can predict a confidence range for a forecast period. Measured values in the forecast period can then be compared to the confidence range to determine the presence of anomalies.

### CLAIMS OF PRIORITY

This patent application claims the benefit of priority U.S. Provisional Patent Application Ser. No. 63/348,640, filed on Jun. 3, 2022, which is hereby incorporated by reference herein in its entirety.

### TECHNICAL FIELD

The present disclosure generally relates to anomaly detection in time series data for sensors.

### BACKGROUND

Sensors, such as biological sensors, can generate time series data based on measurements of biological materials, such as fluids. Anomaly detection in time series data refers to the process of identifying unusual or abnormal patterns in a sequence of data points over time. This is typically done by analyzing the statistical properties of the data. Anomalies in time series data can be caused by a wide range of factors, such as equipment failure. Detecting anomalies can help prevent potential problems and improve the overall performance and reliability of the system.

### BRIEF DESCRIPTION OF THE DRAWINGS

Various ones of the appended drawings merely illustrate example embodiments of the present disclosure and should not be considered as limiting its scope.

FIG. 1 illustrates a block diagram of example portions of a sensor platform.

FIG. 2A illustrates an example measurement period of a sensor.

FIB. 2B illustrates an example graph of measurement values of the measurement period.

FIG. 3 is a flow diagram of a method 300 for detecting anomalies.

FIG. 4 shows an example of converting linear data to non-linear form.

FIG. 5 shows an example of Shanks estimation.

FIG. 6 illustrates an example of inputting historical sensor data into a model.

FIG. 7 illustrates a graphical representation of a confidence range for a forecast period.

### DETAILED DESCRIPTION

Anomaly detection techniques in time series data are described. The techniques can model historical sensor data for a training period using a non-iterative acceleration technique for systems of non-linear equations. The model can include a Bayesian statistical model. The warmup period for training the model can be reduced or bypassed by setting the initial parameters of the model. The trained model can predict a confidence range for a forecast period. Measured values in the forecast period can then be compared to the confidence range to determine the presence of anomalies.

Disclosed herein is a method to detect anomalies in sensor data, the method comprising: receiving historical sensor data in non-linear form; applying a non-iterative acceleration technique for systems of non-linear equations to the historical sensor data in non-linear form to determine a set of coefficients; converting the historical sensor data in non-linear form to linearized data; converting the set of coefficients to a linearized set of coefficients; training a Bayesian statistical model to generate a confidence range corresponding to a forecast period based on the linearized data and the linearized set of coefficients; receiving a sensor value in the forecast period; comparing the sensor value to the confidence range; and in the event the sensor value is detected outside the confidence range, determining an anomaly.

Disclosed also herein is a system comprising one or more processors of a machine; and a memory storing instructions that, when executed by the one or more processors, cause the machine to perform operations comprising: receiving historical sensor data in non-linear form; applying a non-iterative acceleration technique for systems of non-linear equations to the historical sensor data in non-linear form to determine a set of coefficients; converting the historical sensor data in non-linear form to linearized data; converting the set of coefficients to a linearized set of coefficients; training a Bayesian statistical model to generate a confidence range corresponding to a forecast period based on the linearized data and the linearized set of coefficients; receiving a sensor value in the forecast period; comparing the sensor value to the confidence range; and in the event the sensor value is detected outside the confidence range, determining an anomaly.

Disclosed further herein is a machine readable storage medium that, when executed by a machine, cause the machine to perform operations comprising: receiving historical sensor data in non-linear form; applying a non-iterative acceleration technique for systems of non-linear equations to the historical sensor data in non-linear form to determine a set of coefficients; converting the historical sensor data in non-linear form to linearized data; converting the set of coefficients to a linearized set of coefficients; training a Bayesian statistical model to generate a confidence range corresponding to a forecast period based on the linearized data and the linearized set of coefficients; receiving a sensor value in the forecast period; comparing the sensor value to the confidence range; and in the event the sensor value is detected outside the confidence range, determining an anomaly.

Time series data can be used in a variety of applications, such as finance, cybersecurity, and healthcare. In some examples, biological sensors, such as multi-ion sensors, can detect biological materials, such as fluids, and generate time series data representing characteristics of the biological materials. In some sensor systems, the sensor can include a known calibration liquid reservoir, which is sampled in calibration periods. The sensor can then sample an unknown liquid during measurement periods, and the measurement values generated in the measurement periods can be compared to the measurement values in the calibration period to determine characteristics of the unknown liquid.

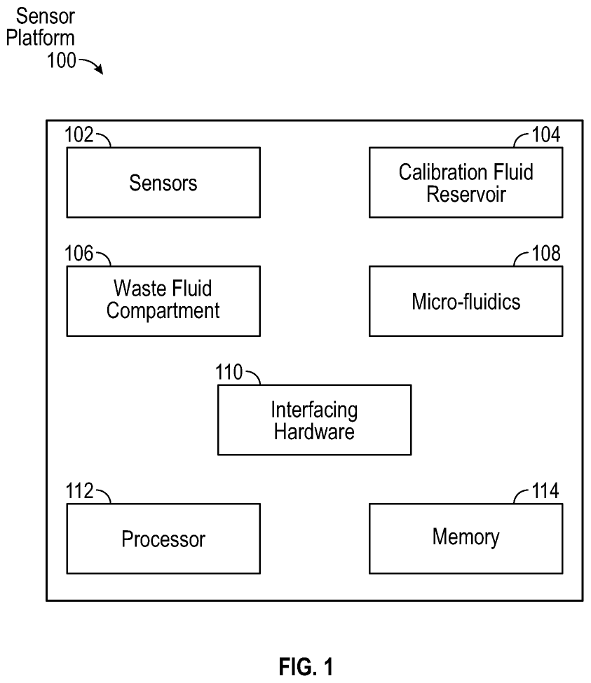

FIG. 1 illustrates a block diagram of example portions of a sensor platform 100. The sensor platform 100 may include sensors 102, a calibration fluid reservoir 104, a waste fluid compartment 106, a micro-fluidics 108, interfacing hardware 110, a processor 112, and a memory 114.

The sensors 102 may include transducer chips, for example, to provide liquid measurement interface for polymer-based ion selective electrodes. In some examples, the sensors 102 can measure calcium, potassium, pH, sodium, etc. The sensors 102 can also measure other properties, such as conductivity, temperature, etc.

The calibration fluid reservoir 104 may hold a calibrant fluid with known properties used to calibrate the sensor platform 100. The waste fluid compartment 106 may hold waste fluids, which have already been tested. The micro-fluidics 108 can interlink components in the sensor platform 100, such as the sensors 102 and the calibration fluid reservoir 104.

In some examples, portions of the sensor platform may be provided as disposable components. For example, a disposable cartridge may include sensors 102, calibration fluid reservoir 104, waste fluid compartment 106, and micro-fluidics 108. Interfacing hardware 110 may provide an interface between the disposable components (e.g., disposable cartridge) and reusable components of the sensor platform 100. The reusable components can include the processor 112 and memory 114.

The processor 112 may be provided as one or more microprocessors, microcontrollers, and other suitable components. The memory 114 may include programs for operations, such as diagnostics, calibration, and anomaly detection.

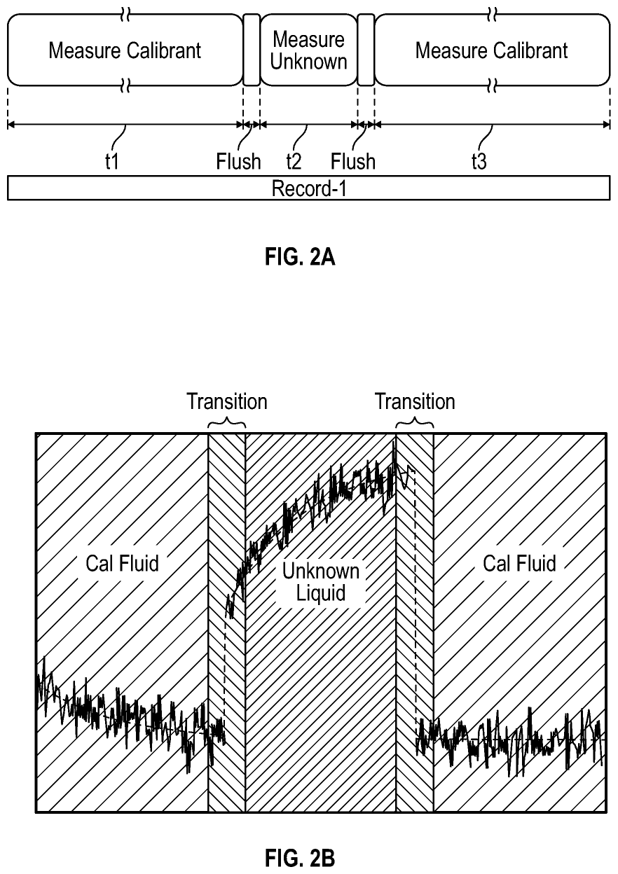

FIG. 2A illustrates an example measurement period of a sensor. The measurement period includes three sections. In a first section t1, a baseline calibrant may be measured by the sensor. In a second section t2, an unknown material can be measured by the sensor. In a third section t3, the baseline calibrant may be measured by the sensor again.

FIB. 2B illustrates an example graph of measurement values of the measurement period. The first section t1 shows the measurement values of the calibration fluid (also referred to as calibrant). The second section t2 shows the measurement values of the unknown liquid. A transition period is between t1 and t2 so that the sensor can flush relevant components so as not to contaminate the measurements of the respective materials. Another transition period is provided between t2 and t3. The third section t3 shows the measurements values of the calibration fluid.

Issues, such as sensor malfunction, can cause anomalies in the sensor results. Anomalies can indicate that the sensor is not working properly and that the sensor results may not be accurate. Anomaly detection in these types of sensors can be difficult. Typically, sensors have a direct input and a direct output, so that anomaly detection can be straightforward using general statistical techniques (e.g., mean, variance, etc.). However, in the type of sensors described above, general statistical techniques may not be applicable. Some sensor systems may use a model that is trained on historical data to predict one sample value in the future. For example, a set of data points may be used to create a linear regression model to predict the next sample value in the future. The measured value may be compared to the predicted value to determine the presence of anomaly. However, because these systems can only predict one value in the future, these systems have severe limitations.

Repetitive techniques to train a model used to detect anomalies are described herein. The techniques described herein can train the model in less time and can predict more values into the future as compared to conventional systems, increasing the efficiency and accuracy of the sensor system.

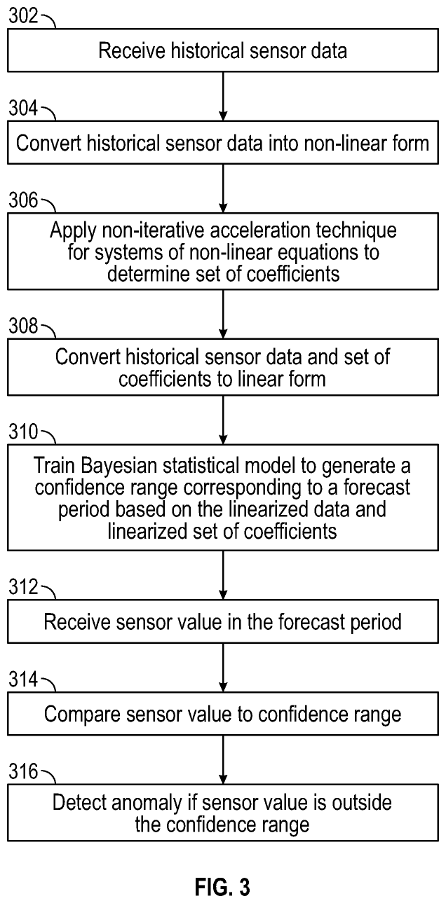

FIG. 3 is a flow diagram of a method 300 for detecting anomalies. Method 300 may be executed during calibration section as described above (e.g., t1 and t3). At operation 302, historical sensor data is received. The historical sensor data may be obtained from the sensor for set time interval for the most recent sensor data (e.g., past 3 minutes, 5 minutes, etc.). The historical sensor data can be in substantially linear form. The historical sensor data can be a set of time series data.

At operation 304, the historical sensor data is converted from linear form to non-linear form, such as exponential form. An exponential trend may be enforced on the linear historical sensor data.

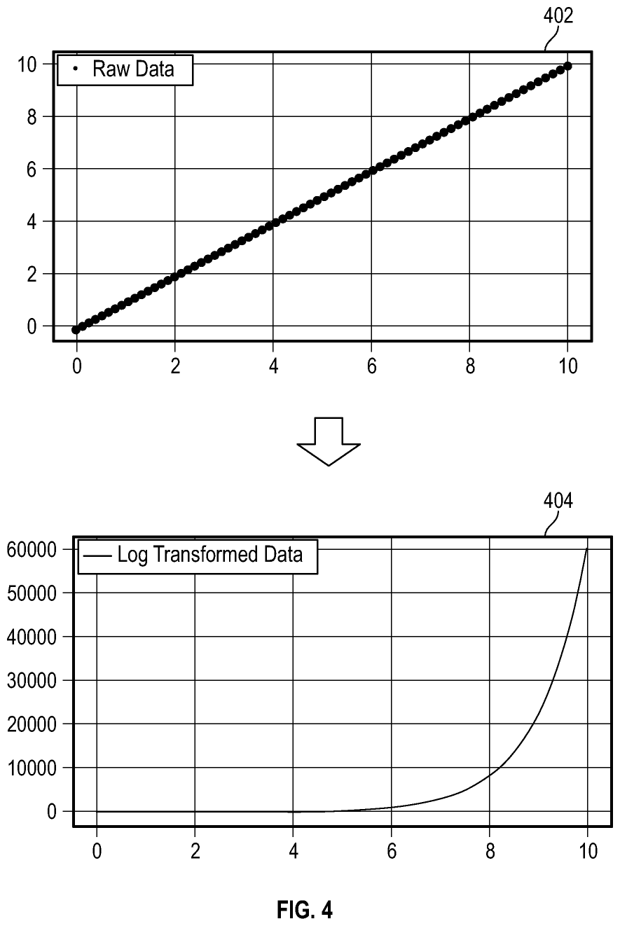

FIG. 4 shows an example of converting linear data to non-linear form. Plot 402 shows linear data, and plot 404 shows the linear data converted to non-linear form. In this example, a log transformation is applied to the linear data to force an exponential trend. In some use cases, the historical sensor data may already be in non-linear form, and in those cases, conversion to non-linear form may not be needed.

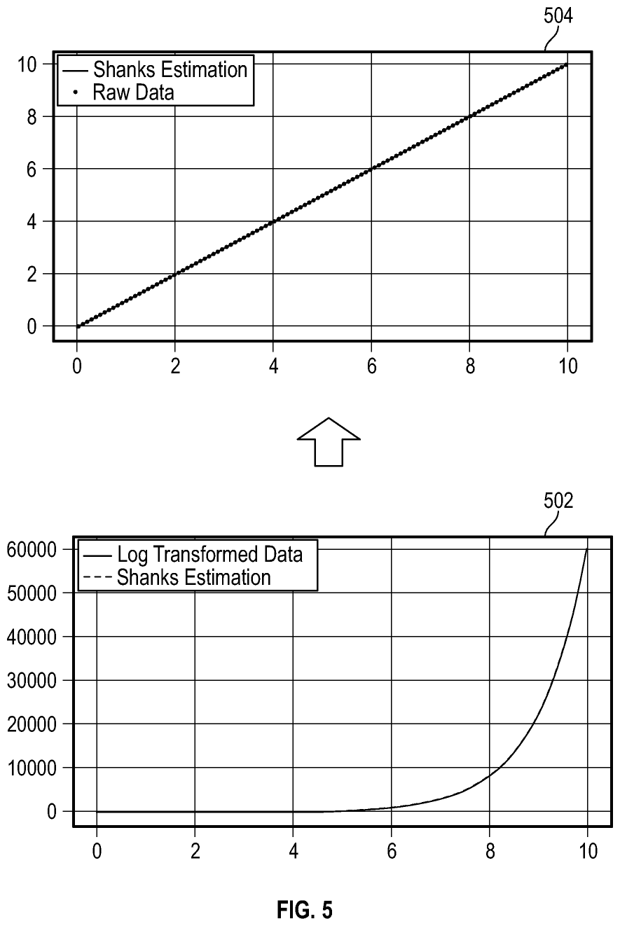

At operation 306, a non-iterative acceleration technique for systems of non-linear equations is applied to the historical sensor data in non-linear form to determine a set of coefficients. For example, a Shanks transformation may be applied to generate Shanks transform coefficients. FIG. 5 shows an example of Shanks estimation. Plot 502 shows a Shanks estimation as compared to the non-linear historical sensor data (i.e., raw data).

For example, a three-coefficient exponential equation can represent the historical sensor data: y(x)=a+b*e^{c,x}, where a represents the asymptote, b represents the scale, and c represents the growth rate. This can be represented by y(x)=A+B*C^{x}, where A, B, and C are intermediate variables are defined as

$$a = A , b = \frac{B}{{c}^{k}} ,$$

and c=C^{1/s}. The data includes (x₁, y₁), (x₂, y₂), (x₃, y₃), . . . , (xₖ, yₖ), . . . (xₙ, yₙ) ranked in increasing/decreasing order of xₖ. Independent coordinates of (x₀, y₀), (x₁, y₁), (x₂, y₂) are fixed s distance apart, where s=equidistant distance of coordinates, k=initial potential, which is x₀. In this example,

$$A = \frac{{y}_{0} \cdot {y}_{2} - {y}_{1}^{2}}{{y}_{0} + {y}_{2} - 2 \cdot {y}_{1}} , B = \frac{{( {y}_{1} - {y}_{0} )}^{2}}{{y}_{0} + {y}_{2} - 2 \cdot {y}_{1}} , C = \frac{{y}_{2} - {y}_{1}}{{y}_{1} - {y}_{0}} .$$

The Shanks transformation and Anderson acceleration can be defined as:

$$S ( {A}_{n} ) = \frac{{A}_{n + 1} \cdot {A}_{n - 1} - {A}_{n}^{2}}{{A}_{n + 1} \cdot 2 {A}_{n} + {A}_{n - 1}} = {A}_{n + 1} - \frac{{( {A}_{n + 1} - {A}_{n} )}^{2}}{( {A}_{n + 1} - {A}_{n} ) - ( {A}_{n} - {A}_{n - 1} )}$$

At operation 308, the historical sensor data in non-linear form is converted to linearized data. Also, the set of coefficients are converted to a linearized set of coefficients. Plot 504 shows a linearized Shanks estimation with the linearized set of coefficients.

At operation 310, a Bayesian statistical model is trained to generate a confidence range corresponding to a forecast period based on the linearized data and linearized set of coefficients. The Bayesian statistical model can include a Metropolis-Hastings algorithm-based technique, such as a Gibbs sampler.

In conventional models, a warmup period (also referred to as burn period or training period) is used in the training of the model by inputting random values to start training. An initial set of random values are assigned to begin training the model. This technique can be time consuming because the model may take some time to be trained using these random initial values.

In contrast, method 300 can set the initial model parameters for the Metropolis-Hastings algorithm-based technique (e.g., Gibbs sampler) based on the linearized set of coefficients (e.g., Shank transform coefficients) to reduce or eliminate (e.g., bypass) the warmup period. In some examples, a diffusion model for machine learning, which uses a Metropolis-Hastings style algorithm can be used.

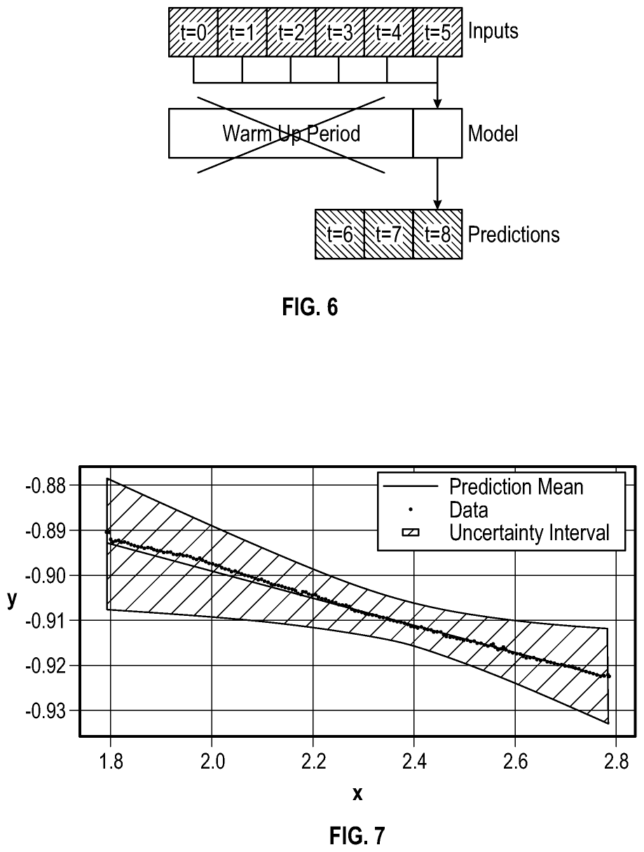

The Bayesian statistical model can then predict values for the confidence range of the forecast period based on the historical sensor data. FIG. 6 illustrates an example of inputting historical sensor data (t=0, t=1, t=2, t=3, t=4, t=5) into the model, and the model generating predicted values (t=6, t=7, t=8). The predicted value can be used to generate confidence range in the forecast period. Also, as shown, no warmup period is required for the model because the model was trained using the linearized set of coefficients as the initial model parameters, thus saving time.

FIG. 7 illustrates a graphical representation of a confidence range for a forecast period. The confidence range is timed dependent. The confidence range can be an envelope created based on the input values.

Unlike conventional models that can typically predict only one value (e.g., 100 milliseconds), the techniques described herein can generate a much longer forecast period. In some examples, the forecast period can be greater than 10 seconds and can be equal to or greater than 2 minutes. The forecast period (also referred to as prediction window) can be increased, which reduces the number of steps needed to generate different forecast periods. Input window size can also be increased, which also reduces the number of steps needed to generate the different forecast periods. For example, an input window size of 5 minutes can be used to generate a 2-minute forecast period. Envelope accuracy is increased and is time dependent. In some examples, a ratio of window size to forecast period can be utilized to set different durations (e.g., 5:2, 7:3).

Returning to FIG. 3, at operation 312, a sensor value in the forecast period is received. The sensor value is received while the sensor is still operating in the calibration section. At operation 314, the sensor value is compared to the confidence range generated by the Bayesian statistical model. If the sensor value is within the confidence range, then no anomaly is detected. If, however, the sensor value is outside the confidence range, an anomaly is detected at operation 316.

The sensor checks if the sensor values in the forecast period breach the envelope of the confidence range. The sensor platform can generate an alert in response to detecting the anomaly for the user. In some examples, a signal indicative of the anomaly can be generated and transmitted from the sensor to alert the user. In some examples, the sensor may generate a trigger mechanism to restart the fluidic exchange to physically alter the fluid in contact with the sensor surface by refilling with new fluid, such as the calibrant.

Method 300 may be performed for different step sizes and repeated in an iterative fashion to detect anomalies in the life cycle of the sensor platform.

### Various Notes

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific implementations in which the invention can be practiced. These implementations are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other implementations can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed implementation. Thus, the following claims are hereby incorporated into the Detailed Description as examples or implementations, with each claim standing on its own as a separate implementation, and it is contemplated that such implementations can be combined with each other in various combinations or permutations. The scope of the invention should be determined with reference to the appended claims, along with the full scope of equivalents to which such claims are entitled.

1. A method to detect anomalies in sensor data, the method comprising:
receiving historical sensor data in non-linear form;
applying a non-iterative acceleration technique for systems of non-linear equations to the historical sensor data in non-linear form to determine a set of coefficients;
converting the historical sensor data in non-linear form to linearized data;
converting the set of coefficients to a linearized set of coefficients;
training a Bayesian statistical model to generate a confidence range corresponding to a forecast period based on the linearized data and the linearized set of coefficients;
receiving a sensor value in the forecast period;
comparing the sensor value to the confidence range; and
in the event the sensor value is detected outside the confidence range, determining an anomaly.

2. The method of claim 1, wherein training the Bayesian statistical model includes:
setting initial model parameters for a Metropolis-Hastings algorithm-based technique based on the linearized set of coefficients to reduce a duration of a training period of training the Bayesian statistical model.

3. The method of claim 2, wherein the Metropolis-Hastings algorithm-based technique includes a Gibbs sampler.

4. The method of claim 1, wherein the non-iterative acceleration technique for systems of non-linear equations includes a Shank transformation and the set of coefficients include Shanks transformation coefficients.

5. The method of claim 1, wherein the confidence range is time dependent.

6. The method of claim 1, wherein the forecast period is greater than 10 seconds.

7. The method of claim 1, wherein the forecast period is equal to or greater than 2 minutes.

8. The method of claim 1, further comprising:
retrieving historical sensor data in substantially linear form; and
converting the historical sensor data in substantially linear form to generate the historical sensor data in non-linear form.

9. A system comprising:
one or more processors of a machine; and
a memory storing instructions that, when executed by the one or more processors, cause the machine to perform operations comprising:
receiving historical sensor data in non-linear form;
applying a non-iterative acceleration technique for systems of non-linear equations to the historical sensor data in non-linear form to determine a set of coefficients;
converting the historical sensor data in non-linear form to linearized data;
converting the set of coefficients to a linearized set of coefficients;
training a Bayesian statistical model to generate a confidence range corresponding to a forecast period based on the linearized data and the linearized set of coefficients;
receiving a sensor value in the forecast period;
comparing the sensor value to the confidence range; and
in the event the sensor value is detected outside the confidence range, determining an anomaly.

10. The system of claim 9, wherein training the Bayesian statistical model includes:
setting initial model parameters for a Metropolis-Hastings algorithm-based technique based on the linearized set of coefficients to reduce a duration of a training period of training the Bayesian statistical model.

11. The system of claim 10, wherein the Metropolis-Hastings algorithm-based technique includes a Gibbs sampler.

12. The system of claim 9, wherein the non-iterative acceleration technique for systems of non-linear equations includes a Shank transformation and the set of coefficients include Shanks transformation coefficients.

13. The system of claim 9, wherein the forecast period is greater than 10 seconds.

14. The system of claim 9, further comprising:
retrieving historical sensor data in substantially linear form; and
converting the historical sensor data in substantially linear form to generate the historical sensor data in non-linear form.

15. A machine readable storage medium that, when executed by a machine, cause the machine to perform operations comprising:
receiving historical sensor data in non-linear form;
applying a non-iterative acceleration technique for systems of non-linear equations to the historical sensor data in non-linear form to determine a set of coefficients;
converting the historical sensor data in non-linear form to linearized data;
converting the set of coefficients to a linearized set of coefficients;
training a Bayesian statistical model to generate a confidence range corresponding to a forecast period based on the linearized data and the linearized set of coefficients;
receiving a sensor value in the forecast period;
comparing the sensor value to the confidence range; and
in the event the sensor value is detected outside the confidence range, determining an anomaly.

16. The method of claim 1, wherein training the Bayesian statistical model includes:
setting initial model parameters for a Metropolis-Hastings algorithm-based technique based on the linearized set of coefficients to reduce a duration of a training period of training the Bayesian statistical model.

17. The method of claim 2, wherein the Metropolis-Hastings algorithm-based technique includes a Gibbs sampler.

18. The method of claim 1, wherein the non-iterative acceleration technique for systems of non-linear equations includes a Shank transformation and the set of coefficients include Shanks transformation coefficients.

19. The method of claim 1, wherein the forecast period is greater than 10 seconds.

20. The method of claim 1, further comprising:
retrieving historical sensor data in substantially linear form; and
converting the historical sensor data in substantially linear form to generate the historical sensor data in non-linear form.
